(19) United States
(12) Patent Application Publication
(10) Pub. No.: US 2019/0387725 A1
(43) Pub. Date: Dec. 26, 2019

(54) Handle System for Fishing Rod

(71) Applicant: John Alan Cooper, Satellite Beach, FL (US)

(72) Inventor: John Alan Cooper, Satellite Beach, FL (US)

(21) Appl. No.: 16/017,607

(22) Filed: Jun. 25, 2018

(51) Int. Cl. A01K 87/08; A01K 89/00

(52) U.S. Cl. CPC A01K 87/08; A01K 89/006

(57) ABSTRACT

A handle system operable in conjunction with a fishing rod and reel has an attachment section and a handle section. An arm of the attachment section is attached to a reel housing. The handle section has an upper handle that is connected to the arm and extends above the reel at an angle less than ninety degrees from the fishing rod.

### FIELD OF THE INVENTION

The present invention relates to fishing and, more particularly, to improved designs of fishing rod systems used in sport fishing.

### BACKGROUND OF THE INVENTION

During fishing it is necessary to raise or otherwise control a fishing rod while under the load of a catch connected to a fishing line. Control of the rod often requires use of muscles which may easily fatigue or lack strength to optimally control the rod when the rod experiences large downward forces. Typically, one hand is placed on the reel handle and the other hand is placed on the rod forward of the reel. There is a need to provide a more optimal arrangement for holding a fishing rod under these conditions.

### BRIEF DESCRIPTION OF THE INVENTION

According to one embodiment of the invention, a handle system is provided which is operable in conjunction with a fishing rod and reel. The handle system includes an attachment section an arm section, and a handle section. The attachment section connects to the arm section and extends away from the reel housing. The handle section sized and shaped to be grasped with the hand of a person is attached to and extends away from the arm section.

### BRIEF DESCRIPTION OF THE FIGURES

Numerous features, aspects, and advantages of the present invention will become better understood when the following detailed description is read with reference to the accompanying drawing in which like characters represent like parts throughout, and wherein:

FIG. 1 depicts a perspective view illustrating a fishing rod system according to an embodiment of the invention.

In accordance with common practice, the various described features may not be drawn to scale in order to emphasize specific features relevant to the invention.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

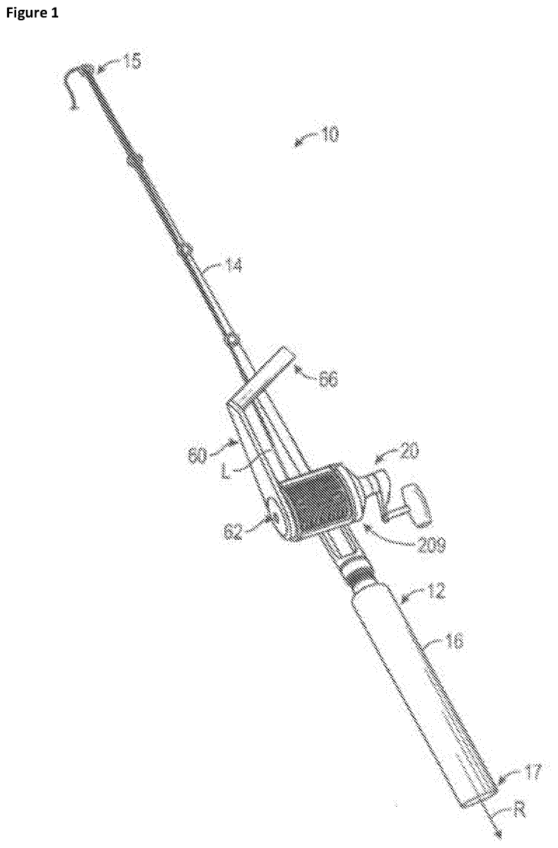

FIG. 1 illustrates a fishing rod system 10 according to an embodiment of the invention. The illustrated rod system 10 is of the type utilized for deep sea fishing, it being understood that the principles of the invention are intended to be applied to a variety of other fishing rod systems. The system 10 comprises a conventional rod 12 having a rod portion 14 of arbitrary length extending to a first end 15 of the rod 12 and a rod handle 16 extending to a second opposing end 17 of the rod.

FIG. 1 depicts an embodiment of the fishing rod system 10, in which the arm 60 may connect to the reel 20. In such an embodiment, the attachment section may have an arm 60 integrally connected to the reel housing 209. The arm 60 may have opposing front and back ends. The back end of the arm 60 may attach to the reel housing 209. This attachment may be due the monolithic nature of the reel housing 209 and arm 60. In some embodiments, the arm 60 may be secured to the reel housing 209. It is not required that the attachment section have an interface plate 62.

The handle section may be connected to the front end of the arm 60. The handle section may include an upper handle 66. The upper handle may have a predefined length and be positioned above the reel 20. The arm 60 may extend away from the reel 20, locating the front end of the arm 60 in front of and above the reel 20. The arm 60 may be configured so that attachment of the upper handle 66 to the front end of the arm 60 places the upper handle 66 in a location that may be grasped by a first hand of the user away from a location at which the fishing line L may contact the first hand. The upper handle may be oriented with respect to the fishing rod to provide a secure grasping surface for a user of the fishing rod. The upper handle may be oriented at a positive angle less than ninety degrees from a level, horizontal plane bisecting the fishing rod in a lengthwise direction. The distal end of the upper handle 66 may be positioned higher, or further away from the fishing rod 12 in a vertical direction, than the proximate end of the upper handle 66, which is attached to the front end of the arm 60.

In some embodiments, the arm 60 may connect to the reel by way of an interface plate 62. The interface plate 62 may be attached to the back end of the arm 60. The interface plate 62 may have a periphery. The arm 60 may extend past the periphery of the interface plate 62. The interface plate 62 may be connected to the reel 20. In some embodiments, a reel mount may be disposed on the interface plate 62. The interface plate 62 may have opposing inner and outer sides. The reel mount may be disposed on the inner side of the interface plate 62, which attaches to the reel 20. The reel mount may be integral to the interface plate 62 or may be secured to the interface plate 62. Embodiments utilizing face plate 62, the arm 60 may terminate at a location above the periphery of the interface plate 62. The upper handle 66 may be located higher than the interface plate 62 when the handle system 60 is installed on the fishing rod 12.

The handle section may include a front plate, which may attach to the arm 60, upper handle 66, or interface plate 62. The upper handle 66 may be located above the front plate.

With the upper handle 66 there is an improved ability to control the rod 12 relative to a conventional arrangement wherein the user places one hand on the reel handle and the other hand on the rod in a position forward of the reel. For purposes of describing advantages of the system 10 it is assumed that the user places the right hand on the reel handle and places the left hand on the upper handle 66, although the invention may be practiced with the user's right hand gripping the upper handle 66. The benefits of the illustrated design are especially apparent when the first end 15 of the rod 12 is subjected to downward forces which occur during a catch. Under such conditions, with the conventional arrangement primary muscle groups applied to support the rod under load with the left hand include the muscles of the forearm as well as bicep muscles. The muscles associated with the forearm are relatively weak compared to the biceps, shoulder muscles and back muscles which can be used to support the rod 12. In a manner somewhat analogous to the adage that a chain is only as strong as its weakest link, the effectiveness of the user's arm is limited by the strength of the muscles controlling the forearm. That is, it is not uncommon for the angler to experience fatigue in the weaker muscle group while trying to maintain line pressure. This can result in a slackening of the line, which can cause the hook to disengage from the fish. According to principles of the invention, by rotating the left forearm to the exemplary θ=30° angle to grip the upper handle 66, the user can more effectively utilize the bicep muscles and shoulder muscles to support the rod 12. In addition, with the left hand firmly holding the canted upper handle 66, the upper; middle and lower back muscle groups can play a more significant role in supporting the rod when experiencing the downward force Summarily, in the past, muscle stress and fatigue, particularly in the forearm, have played a major role in limiting the ability to land fish. The upper handle 66 greatly increases the ability to perform that operation more effectively.

Numerous components of the system 10 have been illustrated, it being understood that the components may be formed from a variety of materials and manufacturing processes. For example, many of the components can be manufactured from plastics or in resin molded processes in addition to manufacture with carbon fiber and various composites used for sports equipment. Embodiments of the invention contemplate use of both level wind reels and manual reels. These reels, including the reel 20, include rotatable spools.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

1. A handle system operable in conjunction with a fishing rod and reel, the handle system comprising:
an attachment section further comprising:
an arm, having opposing front and back ends, wherein the back end of the arm is fixedly attached to a reel housing and the front end of the arm extends toward a first end of the rod, wherein the first end of the rod is distal a rod handle;
a handle section, connected to the front end of the arm between the reel and the first end of the rod, the handle section further comprising:
an upper handle, having a predefined length, positioned above the reel at an angle more than zero degrees and less than ninety degrees from a horizontal plane extending along the length of the fishing rod.

2. The handle system of claim 1 further comprising:
an interface plate attached to the back end of the arm;
a reel mount formed along an inner side of the interface plate and configured to attach to the reel.
